(19) United States
(12) Patent Application Publication
(10) Pub. No.: US 2007/0169487 A1
(43) Pub. Date: Jul. 26, 2007

(54) Liquified gas cryostat

(76) Inventors: Hugh Charles Seton, Aberdeen (GB); James Macdonald Strachan Hutchison, Aberdeen (GB); David Malcolm Brssell, Bath (GB)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 10/589,789

(22) PCT Filed: Feb. 16, 2005
(86) PCT No.: PCT/GB05/00563

§ 371 Date: Feb. 1, 2007

(30) Foreign Application Priority Data
Feb. 16, 2004 (GB) 0403377.5

(51) Int. Cl. F25B 19/00; F17C 13/00

(52) U.S. Cl. 62/51.1; 220/560.04

(57) ABSTRACT

The present invention relates to a liquified gas cryostat which comprises inner and outer walls defining an evacuated housing; a multilayer insulation positioned between the inner and outer walls; and at least one radiation shield circumscribing the inner wall between the inner and outer walls so as to extend over an area of the inner wall which is contacted and cooled by liquified gas in the cryostat when in use, wherein the radiation shield comprises a plurality of rods which are thermally conducting and electrically insulating when the cryostat contains liquified gas.

The present invention relates to a liquified gas cryostat, and in particular to a liquid helium cryostat.

Cryostats are well known for use in magnetic resonance imaging (MRI) systems. The signal to noise ratio (SNR) of the MRI system, and hence MRI image quality, can be improved by lowering the resistance of the receiving coil, which can achieved by cooling the coil in a cryostat. Maximising SNR is particularly important for MRI systems using low magnetic field strengths. Particularly low SNR can be achieved using a low-T_{c} superconductor for the coil, T_{c} being the superconducting transition temperature. An example of a suitable low-T_{c} superconductor is niobium, this being a refractory metal which can easily be formed into coils of any required shape. The T_{c} of niobium is approximately 9K, and requires that it must be cooled by liquid helium at 4.2K.

Liquid helium requires specialised handling, and cryostats containing liquid helium must be sufficiently insulated to ensure that the liquid helium hold-time is acceptable. For commercially available cryostats, a typical 5 litre fill of liquid helium may take 4-5 days to evaporate.

Typical liquid helium cryostats comprise a double-walled dewar vessel in which the space between the walls is evacuated to reduce conductive heat transfer to the liquid helium. The walls are typically fabricated from glass reinforced plastic (GRP) to minimise signal losses due to eddy currents. A number of layers of multilayer insulation (MLI), for example 30 layers, are typically placed between the walls to reduce radiative heat flux. The MLI may comprise layers of fabric each coated with a metallic layer to create discrete, self-defined areas of metallisation. The fabric may be, for example, a polyester, and the metallic layer may comprise gold or aluminium. UK patent number 2351549 discloses an improvement in cryostat MLI, wherein discontinuities in the metallic layer arise due to crossing of the threads of the woven fabric. The metallised fabric can thus act as a heat reflector, but with the discrete nature of the metallised areas preventing electrical conduction, and hence losses due to eddy currents.

However, the efficiency of the MLI layers can be further improved by the inclusion of a radiation shield between the inner and outer walls of the cryostat at an intermediate temperature. The shield can be cooled either by contact with a liquid nitrogen reservoir (at 77K) or a cryo-cooler, or by being thermally anchored to a point on the tube venting the helium gas, sometimes called the cryostat “neck”, evolved as the liquid helium boils off. The “cold end” of the vent tube is at a temperature near that of liquid helium (4.2K), which rises along the length of the tube to almost room temperature at the top of the cryostat. Thus, in principle, any shield temperature in this range can be obtained by correctly positioning the anchor of the shield to the tube. The shield acts by intercepting the radiant heat flux from the outside wall of the cryostat (reduced by any intervening MLI layers) and conducting this heat to the anchor point on the tube.

In conventional cryostats, copper or aluminium may typically be used to make radiation shields since these materials have high thermal conductivity in the temperature region of 60-150K. However, these materials also have the disadvantage of high electrical conductivity at low temperatures, which gives rise to eddy currents losses.

Attempts at reducing eddy currents losses in the radiation shield have been made, for example, by using electrically insulated strips or wires of aluminium or copper, which are set lengthways into a GRP tube. This construction ensures that the radiant heat incident on the shield is conducted efficiently up the length of the cryostat, but that the areas of any electrically conducting paths are kept to a minimum, since it is these which give rise to eddy current signal losses. UK patent number 2331798 discloses a cryostat having a radiation shield which is formed from an electrical insulator having a good thermal conductivity, for example a sintered ceramic material (for example, alumina, aluminium nitride, or silicon carbide), sapphire or diamond powder composite.

However, such radiation shields still present problems. For example, sintered ceramic materials can be expensive, and heavy. They can also be difficult to produce in continuous sheets, which can result in radiation shields of a limited size, which in turn can limit the overall size of the cryostat, which in turn can further limit the size of sample to be scanned.

The present invention seeks to provide a liquified gas cryostat which can overcome the aforementioned problems with conventional cryostats.

According to the present invention there is provided a liquified gas cryostat which comprises inner and outer walls defining an evacuated housing, a multilayer insulation positioned between the inner and outer walls, and at least one radiation shield circumscribing the inner wall between the inner and outer walls so as to extend over an area of the inner wall which is contacted and cooled by liquified gas in the cryostat when in use, wherein the radiation shield comprises a plurality of rods which are thermally conducting and electrically insulating when the cryostat contains liquified gas.

A radiation shield which comprises thermally conducting and electrically insulating rods (hereinafter referred to as “shield rods”), can afford a greater flexibility of cryostat size, compared to when the radiation shield is formed of a continuous sheet of material, for less cost. Thus, the cryostat of the present invention may in principle have any desired size: a cryostat having a larger diameter would simply require more shield rods to form the radiation shield than a cryostat having a smaller diameter. Shield rods can also be less expensive to manufacture than a continuous sheet of shield material, in particular for sintered ceramic materials, such as alumina, aluminium nitride, and silicon carbide. A radiation shield which is formed from shield rods, versus a continuous sheet of shield material, can also have weight advantages.

The radiation shield used in the cryostat of the present invention thus comprises a plurality of rods which are thermally conducting and electrically insulating when the cryostat contains liquified gas. Preferred materials for forming the shield rods include sintered ceramic materials, for example alumina, aluminium nitride, and silicon carbide, and sapphire or diamond powder composite. Such materials have good thermal conductivity, and are electrically insulating to reduce eddy currents, at the operating temperature of the radiation shield. A preferred material for forming the shield rods is alumina.

The shield rods may in principle have any desired dimensions. For example, as they are not employed to prevent leakage, or take any physical strain, they may have a small diameter, for example approximately from 1 to 2 mm. The shield rods may be manufactured to a particular predetermined diameter and length, and can be shortened as required. For example, shield rods for use in a radiation shield for a typical cryostat may have a length of from 30 to 60 cm.

The number of shield rods to be employed in the radiation shield used in the present invention will depend upon the dimensions of the radiation shield and the individual shield rods to be employed. For example, a radiation shield having a diameter of 10 cm has a circumference of approximately 314 mm, meaning that 150 shield rods having a diameter of 1 mm can be equally spaced around the circumference at a spacing of approximately 1 mm.

The radiation shield preferably comprises a substrate on which the shield rods are positioned. The substrate is preferably tubular or cylindrical, for circumscribing the inner wall between the inner and outer walls, and made of a suitable material, for example GRP. In a preferred embodiment of the present invention, the radiation shield comprises a tubular GRP substrate on which alumina shield rods are positioned, and an end plate fixed to the substrate. The end plate is preferably also formed from alumina, and may have a similar thickness to the shield rods, for example approximately from 1 to 2 mm.

In use, the radiation shield is preferably cooled so as to be at an intermediate temperature between room temperature, for example 300K, and the temperature of the liquified gas within the cryostat, for example 4.2K for liquid helium and 77K for liquid nitrogen. The radiation shield may be cooled by contact with a liquid nitrogen reservoir (at 77K) or a cryo-cooler, or by being thermally anchored to the cryostat at the cryostat “neck”, i.e. the tube through which gas is vented, as the liquified gas boils off. The “cold end” of the neck is at a temperature near that of the liquified gas within the cryostat, the temperature rising along the length of the neck to almost room temperature at the top of the cryostat. Thus, in principle, any radiation shield temperature in this range can be obtained by correctly anchoring the radiation shield to the neck.

The radiation shield may thus be in contact with the cryostat neck via a heat exchanger, for transferring heat from the radiation shield to the cryostat neck, thereby cooling the radiation shield. The heat exchanger may be fabricated from metal, such as copper or aluminium, or a ceramic material, and may in the form of strips or rods, attached at one end to the shield rods and at the other to the cryostat neck. In those preferred embodiments in which the shield rods are alumina, the heat exchanger preferably comprises aluminium rods.

The radiation shield of the cryostat of the present invention may be used with all types of low noise cryostats including those required for biomagnetism determinations.

The cryostat of the present invention comprises inner and outer walls defining an evacuated housing, for reducing heat conduction by gas to the liquified gas within the cryostat. The cryostat may thus comprise a double-walled dewar vessel, fabricated from, for example, GRP.

The cryostat of the present invention also comprises a multilayer insulation (MLI) positioned between the inner and outer walls. The MLI may be in any suitable form as is known to those skilled in the art. Thus, the MLI may comprise a metallised substrate, for example a woven layer of polyester fabric. The substrate preferably comprises metallised areas which do not exceed 2 mm by 2 mm, and more preferably comprises metallised elements of approximately from 500 μm to 20 μm. Such metallised substrates provide a self-defined, highly uniform, low eddy current loss, reflective insulating material for use in forming the MLI. A particularly preferred MLI for use in the present invention is disclosed in UK patent number 2351549.

The cryostat of the present invention is particularly suitable for use with liquid helium or liquid nitrogen.

The cryostat of the present invention preferably houses a Superconducting Quantum Interference Device (SQUID) for MRI or NMR scanning.

The present invention will now be described in detail with reference to the accompanying drawings in which:

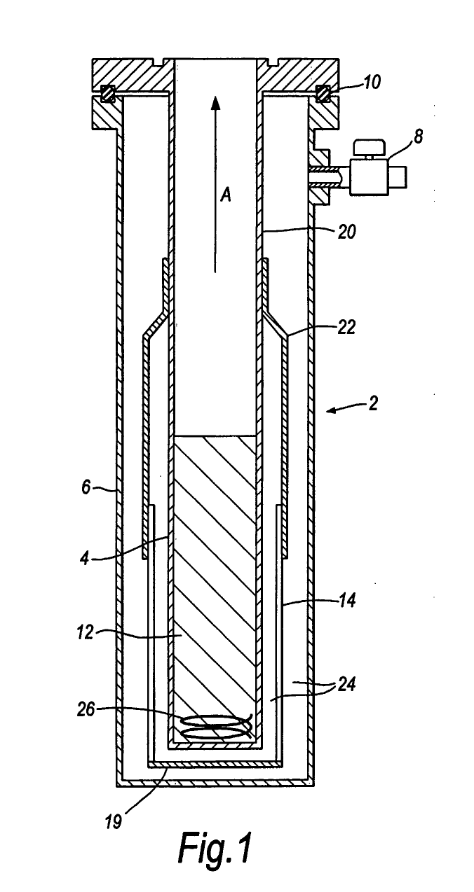

FIG. 1 which shows a vertical cross-sectional view of an embodiment of a cryostat of the present invention; and

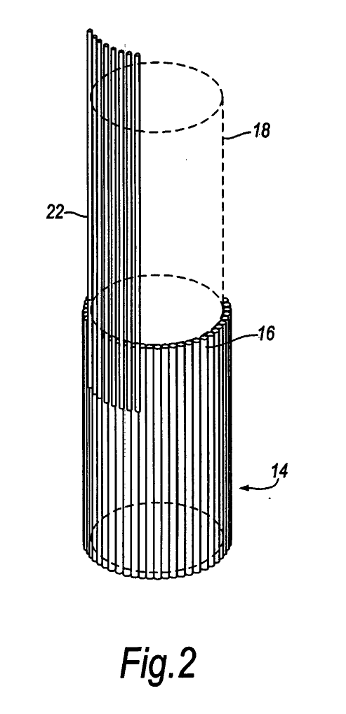

FIG. 2 shows a perspective cutaway view of the end plate, radiation shield, and heat exchanger of the cryostat shown in FIG. 1.

Referring to the figures, an embodiment of the cryostat of the present invention comprises a dewar vessel 2 having an inner wall 4 and an outer wall 6. The inner 4 and outer 6 walls are formed from GRP to minimise losses due to eddy currents. The space between the inner 4 and outer 6 walls is evacuated via vacuum valve 8 for reducing heat conduction by gas to the liquified gas within the cryostat, and the inner 4 and outer 6 walls are closed at their upper ends by a vacuum seal 10. Liquid helium 12 is contained within the dewar vessel 2.

A radiation shield 14 is positioned between the inner 4 and outer 6 walls, circumscribing the inner wall 4 so as to extend over an area of the inner wall 4 which is in contact with and cooled by the liquid helium 12. The radiation shield comprises a plurality of alumina rods 16 having a diameter of approximately 1 mm on a GRP substrate 18 (see FIG. 2). The radiation shield 14 also comprises an alumina end plate 19 having a thickness of approximately 2 mm, which is fixed to the substrate 18 by epoxy resin. The alumina end plate is thermally linked to each alumina rod so that it is cooled to the same temperature as the shield. In this way, the end plate intercepts radiated heat which would otherwise reach the end of the liquid cryostat volume.

Helium gas which boils off from the liquid helium 12 is vented through a neck 20 of the cryostat, as indicated by arrow A in FIG. 1. The radiation shield 14 is connected to the neck 20 via a heat exchanger 22, for transferring heat from the radiation shield 14 to the neck 22, thereby cooling the radiation shield 14. The heat exchanger 22 comprises aluminium rods which connect with the alumina rods 16. It will be apparent that the alumina rods are thermally linked to the rods of the heat exchanger 22 and the rods of the heat exchanger 22 are thermally linked to the neck.

Alternatively, the radiation shield 14 may be thermally isolated from the cryostat neck 20 and cooled by a cryo-cooler.

More than one radiation shield may be used and, in these circumstances, a mixture of cooling by boiled-off helium gas and cooling by cryo-cooler may be used.

The embodiment of the present invention shown in the figures further comprises a multilayer insulation 24 positioned between the inner 4 and outer 6 walls. The multilayer insulation 24 comprises 30 to 60 layers of aluminised Mylar® to reduce heat flux. Generally, fewer insulating layers are preferred near and covering the base of the cryostat to minimise losses near the detection coil (shown in FIG. 1 at 26), with more layers adjacent the sides of the radiation shield 14 to minimise liquid helium boil-off. The insulating layers have a thin coating of aluminium, comprising discrete aluminium areas having a size of less than 2 mm by 2 mm to prevent electrical conduction.

The main field of use of the cryostat of the present invention is in NMR and MRI determinations performed at room temperature on a subject, such as a patient. In particular, a liquid helium temperature tuned superconducting surface coil coupled to a SQUID detector operating in such a cryostat allows MR images with high signal to noise ratio to be obtained at low field strengths.

1. A liquified gas cryostat which comprises:
inner and outer walls defining an evacuated housing;
5 a multilayer insulation positioned between the inner and outer walls; and
at least one radiation shield circumscribing the inner wall between the inner and outer walls so as to extend over an area of the inner wall which is contacted and cooled by liquified gas in the cryostat when in use,
wherein the radiation shield comprises a plurality of rods which are thermally conducting and electrically insulating when the cryostat contains liquified gas.

2. A cryostat according to claim 1 wherein the rods are formed from a sintered ceramic material, or sapphire or diamond powder composite.

3. A cryostat according to claim 2 wherein the rods are 20 formed from alumina, aluminium nitride, or silicon carbide.

4. A cryostat according to claim 1 wherein the rods have a diameter of from 1 to 2 mm.

5. A cryostat according to claim 1 wherein the radiation shield comprises a glass reinforced plastic substrate on which the rods are positioned.

6. A cryostat according to claim 1 wherein the radiation 30 shield comprises an end plate fixed to the substrate.

7. A cryostat according to claim 6 wherein the end plate is formed from alumina.

8. A cryostat according to claim 6 wherein the end plate has a thickness of from 1 to 2 mm.

9. A cryostat according to claim 1 wherein the radiation shield in use is cooled by being in contact with a venting 5 tube of the cryostat through which gas is vented, as liquified gas boils off, via a heat exchanger, for transferring heat from the radiation shield to the tube.

10. A cryostat according to claim 9 wherein the heat 10 exchanger is fabricated from metal or a ceramic material.

11. A cryostat according to claim 9 wherein the heat exchanger is in the form of strips or rods or material.

12. A cryostat according to claim 10 wherein the heat exchanger comprises rods of aluminium.

13. A cryostat according to claim 1 which contains liquid helium.

14. A cryostat according to claim 1 which houses a Superconducting Quantum Interference Device for MRI or NMR scanning.

15. (canceled)
